(19) United States
(12) Patent Application Publication
(10) Pub. No.: US 2025/0080198 A1
(43) Pub. Date: Mar. 6, 2025

(54) METHOD FOR BEAM MANAGEMENT OF AN ANTENNA ARRAY IN AN ELECTRONIC DEVICE

(71) Applicant: MEDIATEK INC., Hsin-chu (TW)

(72) Inventors: Chih-Wei Chiu, Hsinchu City (TW); Wei-Hsuan Chang, Hsinchu City (TW); Yeh-Chun Kao, Hsinchu City (TW); Chih-Wei Lee, Hsinchu City (TW)

(73) Assignee: MEDIATEK INC., Hsin-chu (TW)

(21) Appl. No.: 18/242,012

(22) Filed: Sep. 5, 2023

Related U.S. Application Data
(60) Provisional application No. 63/377,739, filed on Sep. 30, 2022.

(51) Int. Cl. H04B 7/06; H04B 1/3827; H04B 7/0404; H04B 17/10

(52) U.S. Cl. CPC H04B 7/06952; H04B 1/3838; H04B 7/0404; H04B 17/103

(57) ABSTRACT

A beam management method of an electronic device includes transmitting a detecting signal, receiving a reflecting signal of the detecting signal, determining blocked antennas of an antenna array of the electronic device according to the reflecting signal, and exciting only unblocked antennas of the antenna array. This will improve the radiation efficiency of the antenna array.

### BACKGROUND

In recent years, mobile devices containing functions using 5G with millimeter wave (mmWave) antenna array gradually prosper. The mmWave antenna array is small enough to be set in the mobile device due to its high carrier frequency. Moreover, the mmWave antenna array can be used to gain better equivalent isotropically radiated power (EIRP) by performing beamforming in a small angular area. To perform beamforming, a beam management which includes phase and magnitude settings of each beam, initial beam alignment, and tracking, as well as recovering from beam failures should be done by modem. However, conventional beam management only concerns a free space case and excites all antennas in the mmWave antenna array at the same time. When some antennas are blocked by hand, the EIRP would decrease because the blocked antennas continue to radiate with low efficiency, yielding an undesirable result.

FIG. 1 shows cumulative distribution functions (CDFs) of the EIRP performance based on a fully excited antenna array with 0, 1, and 2 antennas being blocked according to prior art. The radiation powers at CDF 50% are 12.71, 14.59, 16.2 dBm when 2, 1, and 0 antennas are blocked respectively. The radiation powers at CDF 100% are 21.14, 24.13, 26.74 dBm when 2, 1, and 0 antennas are blocked respectively. The data show that the EIRP decreases as the number of the blocked antennas increases by using conventional beam management method.

### SUMMARY

A beam management method of an antenna array in an electronic device comprises detecting blocked antennas of an antenna array of the electronic device, and exciting only unblocked antennas of the antenna array.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows cumulative distribution functions (CDFs) of the equivalent isotropically radiated power (EIRP) performance based on a prior art fully excited antenna array with 0, 1, and 2 antennas being blocked.

FIG. 2 is a block diagram of an electronic device according to an embodiment of the present invention.

FIG. 3 is a beam management method of the electronic device in FIG. 2.

FIG. 4A shows beams when no antenna of the antenna array in FIG. 2 is blocked.

FIG. 4B shows beams when an antenna of the antenna array in FIG. 2 is blocked.

FIG. 5A is a radiation power density heat map when all four antennas in the antenna array are in free space.

FIG. 5B is a radiation power density heat map implemented by the beam management method in FIG. 3 when one antenna in the antenna array is blocked by hand.

FIG. 5C is a radiation power density heat map implemented by the beam management method in FIG. 3 when two antennas in the antenna array are blocked by hand.

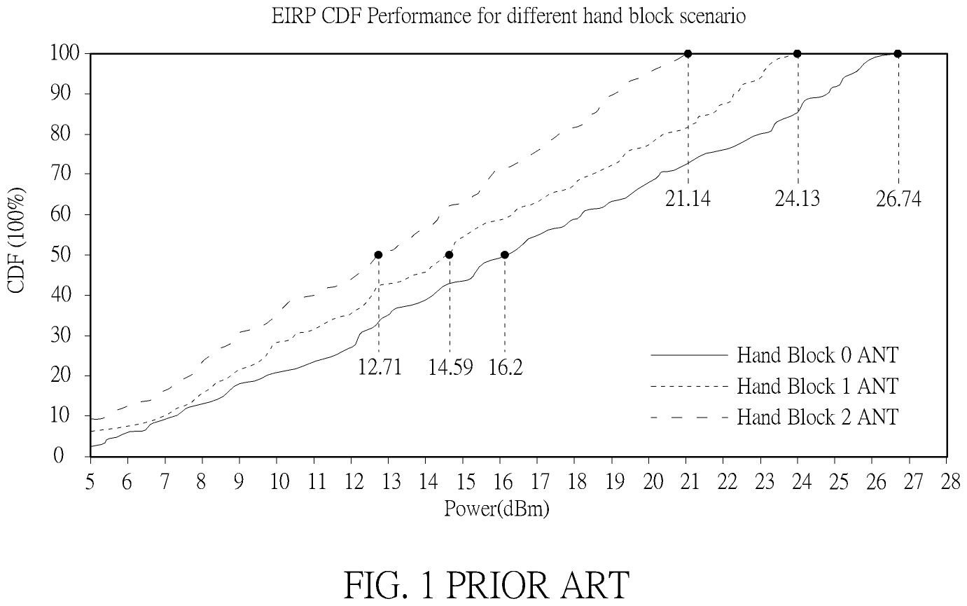

### DETAILED DESCRIPTION

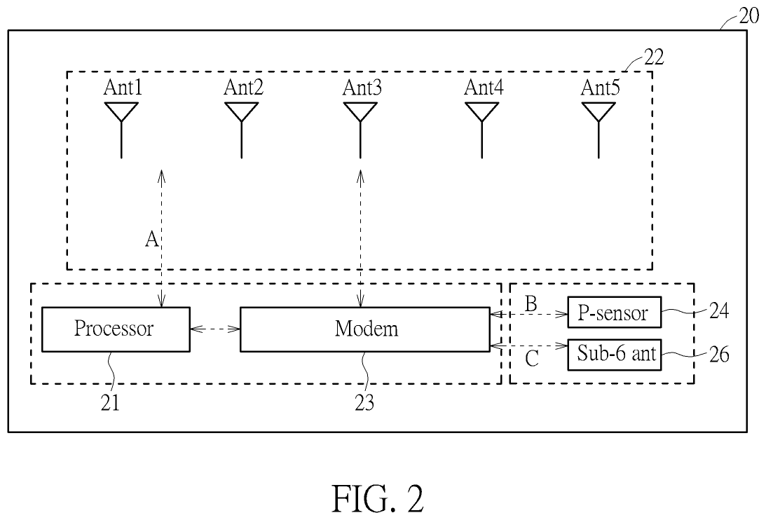

FIG. 2 is a block diagram of an electronic device 20 according to an embodiment of the present invention. The electronic device 20 can be a mobile device. The electronic device 20 comprises a processor 21, an antenna array 22 coupled to the processor 21, and a modem 23 coupled to the processor 21 and the antenna array 22. The antenna array 22 can be but not limited to a millimeter wave (mmWave) antenna array or a sub-6 GHZ antenna array. The electronic device 20 may also comprise a proximity sensor 24 coupled to the modem 23, or a sub-6 GHZ antenna 26 coupled to the modem 23.

The processor 21 is used for determining blocked antennas, and the modem 23 is used for performing an antenna beam management. The antenna beam management can be based on type A, B, and C. For type A, the processor 21 controls the modem 23 to transmit a detecting signal through the antenna array 22 and receive a reflecting signal. If the power of the reflecting signal changes to be more than a threshold, the processor 21 will feedback to the modem 23, and the modem 23 will disable the blocked antennas and dynamically focus the excited power on the unblocked antennas to get better performance. For type B, the proximity sensor 24 is installed in the electronic device 20. The proximity sensor 24 can transmit a detecting signal and receives a reflecting signal from an object or use other mechanisms to detect an object. Then, the processor 21 can determine blocked antennas based on the reflecting signal of the proximity sensor 24. For type C, a sub-6 GHZ antenna 26 in the electronic device 20 can transmit a detecting signal and receive a reflecting signal or use other mechanism to detect an object. Then, the processor 21 can determine blocked antennas based on the reflecting signal of the sub-6 GHZ antenna 26.

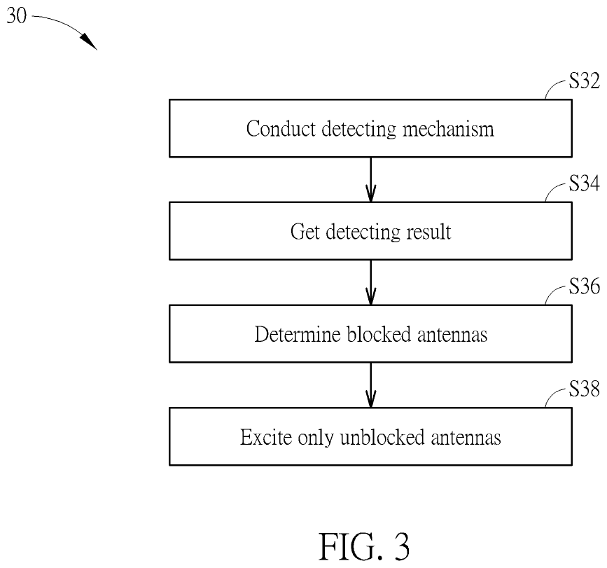

FIG. 3 is a beam management method 30 of the electronic device 20. The beam management method 30 includes the following steps:

Step S32: conduct detecting mechanism by a plurality of antennas or a sensor;

Step S34: get a detecting result from the antennas or the sensor;

Step S36: determine blocked antennas of the antenna array 22 of the electronic device according to the detecting result; and

Step S38: excite only unblocked antennas of the antenna array 22.

In Steps S32 and S34, the processor 21 may use the modem 23 to control the antenna array 22, the proximity sensor 24 or the sub-6 GHZ antenna 26 to transmit the detecting signal and receive the detecting result or to use other mechanisms to detect an object.

If the antenna array 22 is used to conduct detecting mechanism and get the detecting result, then the electronic device 20 does not need to comprise the proximity sensor 24 and the sub-6 GHZ antenna 26. If the proximity sensor 24 or the sub-6 GHZ antenna 26 is used to conduct detecting mechanism and get the detecting result or to use other mechanisms to detect an object, then the antenna array 22 is not used to conduct detecting mechanism and get the detecting result. If the antenna array 22 is the sub-6 GHZ antenna array, then the sub-6 GHZ antenna 26 can be omitted because the sub-6 GHZ antenna array can also be used to conduct detecting mechanism and get the detecting result or to use other mechanisms to detect an object.

In Step S36, the processor 21 determines blocked antennas of the antenna array 22 according to the detecting result, and uses the modem 23 to focus and excite only unblocked antennas of the antenna array 22 to perform beamforming.

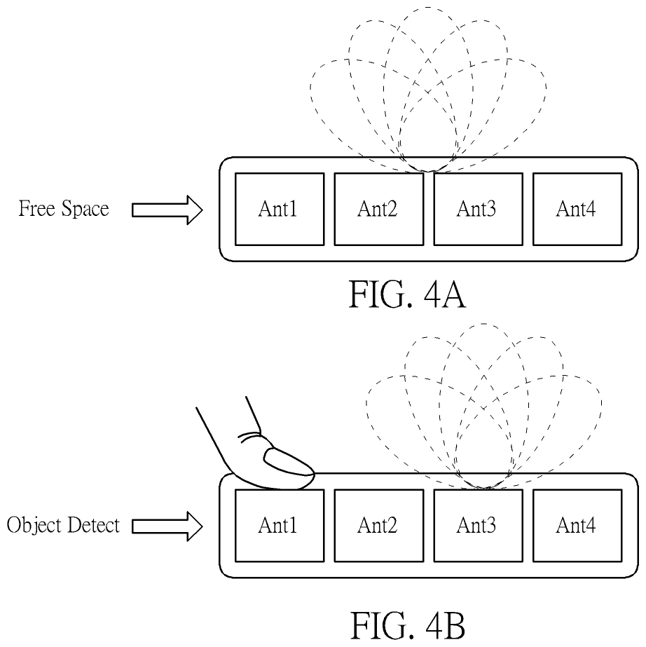

FIG. 4A shows beams when no antenna of the antenna array 22 is blocked. FIG. 4B shows beams when an antenna of the antenna array 22 is blocked. When no antenna of the antenna array 22 is blocked, the modem 23 excites all antennas of the antenna array 22 for beamforming. When some antennas of the antenna array 22 are blocked, the modem 23 focuses and excites only unblocked antennas of the antenna array 22 for beamforming, thus total efficiency of the antenna array is better, and the equivalent isotropically radiated power (EIRP) of the antenna array 22 shall increase.

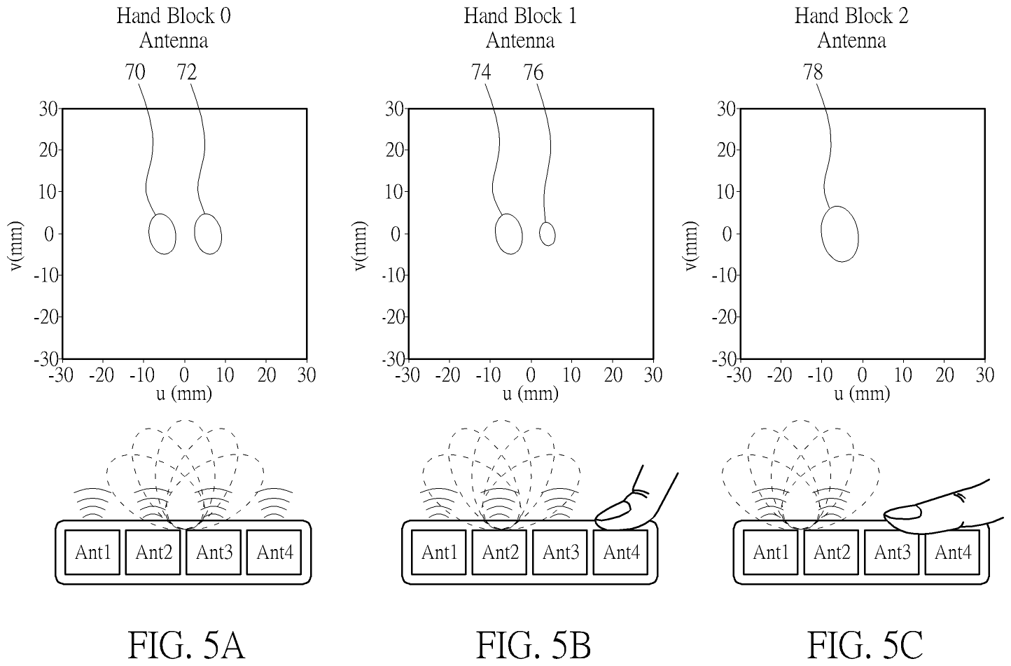

FIG. 5A is a radiation power density heat map when all four antennas in the antenna array are in free space. FIG. 5B is the radiation power density heat map implemented by the beam management method 30 when one antenna in the antenna array is blocked by hand. FIG. 5C is the radiation power density heat map implemented by the beam management method 30 when two antennas in the antenna array are blocked by hand. In FIG. 5A, the two high power areas 70, 72 have maximum power density outputs of about 10 W/m². In FIG. 5B, the left high power density area 74 has a maximum power density output of about 15 W/m², the right high power density area 76 has a maximum power density output of about 8 W/m². In FIG. 5C, the left high power density area 78 has a maximum power density output of about 20 W/m², and on the right side, there is no high power density area. Thus when some of the antennas are blocked by hand, the power density output corresponding to the position of unblocked antennas is increased while the power density output corresponding to the position of blocked antennas is decreased, achieving a higher realized gain and reducing power density exposure to human body.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A beam management method of an electronic device comprising:
detecting blocked antennas of an antenna array of the electronic device; and
exciting only unblocked antennas of the antenna array.

2. The method of claim 1, wherein detecting the blocked antennas of the antenna array of the electronic device comprises:
transmitting a detecting signal;
receiving a reflecting signal of the detecting signal; and
determining the blocked antennas of the antenna array according to the reflecting signal.

3. The method of claim 2, wherein transmitting the detecting signal is transmitting the detecting signal from a proximity sensor of the electronic device.

4. The method of claim 3, wherein receiving the reflecting signal of the detecting signal is receiving the reflecting signal of the detecting signal by the proximity sensor.

5. The method of claim 2, wherein transmitting the detecting signal is transmitting the detecting signal from a sub-6 GHZ antenna.

6. The method of claim 5, wherein receiving the reflecting signal of the detecting signal is receiving the reflecting signal of the detecting signal by the sub-6 GHZ antenna.

7. The method of claim 2, wherein determining the blocked antennas of the antenna array according to the reflecting signal is determining the blocked antennas of the antenna array according to the reflecting signal by a processor.

8. The method of claim 1, wherein exciting only unblocked antennas of the antenna array is exciting only unblocked antennas of the antenna array by a modem.

9. The method of claim 8 further comprising performing beamforming with only the unblocked antennas.

10. The method of claim 9, wherein performing beamforming with only the unblocked antennas is performing beamforming with only the unblocked antennas by the modem.

11. An electronic device, comprising:
an antenna array;
a processor coupled to the antenna array;
a modem coupled to the antenna array and the processor;
a proximity sensor coupled to the modem; and
a sub-6 GHZ antenna coupled to the modem;
wherein the electronic device detects blocked antennas of the antenna array of the electronic device and excites only unblocked antennas of the antenna array.

12. The electronic device of claim 11, wherein the modem controls the proximity sensor to detect the blocked antennas of the antenna array.

13. The electronic device of claim 11, wherein the modem controls the sub-6 GHZ antenna to detect the blocked antennas of the antenna array.

14. The electronic device of claim 11, wherein the modem controls the antenna array to detect the blocked antennas of the antenna array.

15. The electronic device of claim 11, wherein the antenna array is a millimeter wave antenna array.

16. The electronic device of claim 11, wherein the antenna array is a sub-6 GHz antenna array.

17. The electronic device of claim 11, wherein the electronic device is a mobile device.

18. The electronic device of claim 11, wherein the electronic device detects the blocked antennas of the antenna array of the electronic device comprises:
transmitting a detecting signal;
receiving a reflecting signal of the detecting signal; and
determining the blocked antennas of the antenna array according to the reflecting signal.

19. The electronic device of claim 11 wherein the modem excites only the unblocked antennas.

20. The electronic device of claim 11 wherein the modem performs beamforming with only the unblocked antennas.
